(19) United States
(12) Patent Application Publication
(10) Pub. No.: US 2018/0181652 A1
(43) Pub. Date: Jun. 28, 2018

(54) SEARCH METHOD AND DEVICE FOR ASKING TYPE QUERY BASED ON DEEP QUESTION AND ANSWER

(71) Applicant: BEIJING BAIDU NETCOM SCIENCE AND TECHNOLOGY CO., LTD., Beijing (CN)

(72) Inventor: Xingwu SUN, Beijing (CN)

(21) Appl. No.: 15/851,018

(22) Filed: Dec. 21, 2017

(30) Foreign Application Priority Data
Dec. 28, 2016 (CN) 201611235417.1

(51) Int. Cl. G06F 17/30; G06F 17/27

(52) U.S. Cl. CPC G06F 17/30684; G06F 17/30873; G06F 17/2785; G06F 17/30864

(57) ABSTRACT

The present disclosure provides a search method and a search device for asking type query based on deep question and answer. The method includes: extending an asking type query, to obtain an extended query semantically related to the asking type query; performing a search according to the extended query, to obtain pages matching the extended query; performing a feature analysis on each of paragraphs in the pages, to obtain a score of each of the paragraphs; and selecting a target paragraph as a search result from the paragraphs according to the score.

### CROSS-REFERENCE TO RELATED APPLICATION

The present application is based upon and claims priority to Chinese Patent Application No. 201611235417.1, filed on Dec. 28, 2016, the entirety contents of which are incorporated herein by reference.

### FIELD

The present disclosure relates to a field of information search technology, and more particularly to a search method and a search device for asking type query based on deep question and answer.

### BACKGROUND

Deep question and answer means a technology which can understand languages of human, intelligently identify meanings of a question, and extract an answer to the question from a huge number of internet data.

In an information searching process in the related art, a user can set his own query, thus the search engine can search according to the query, and return search results to the user. In a search engine running process, the inventor finds that, the user may ask a question as a query in some cases, i.e., the query is an asking type query. In this case, when information searching technology in the related art is used, the search engine takes the question input by the user as a query, and performs word segmentation on the query to obtain words in the query, and then takes pages that contain at least one of the words in the query as search results.

In some cases, a page is a result of the query, but the query does not appear in the page, thus the page can not be provided to the user as a search result. For example, when a query is “effect and function of angelica”, a page with “angelica can enrich blood and moisten the intestines, and its nature is warm” is not contained in the search results. Therefore, in the related art, when a search is performed based on an asking type query, search results are not comprehensive enough, and search efficiency is poor.

### SUMMARY

Embodiments of the present disclosure seek to solve at least one of the problems existing in the related art to at least some extent.

For this, a first objective of the present disclosure is to provide a search method for asking type query based on deep question and answer, to solve the problem that the search efficiency is poor when a search is performed based on an asking type query in the related art.

A second objective of the present disclosure is to provide a search device for asking type query based on deep question and answer.

A third objective of the present disclosure is to provide another search device for asking type query based on deep question and answer.

A forth objective of the present disclosure is to provide a non-transitory computer-readable storage medium.

A fifth objective of the present disclosure is to provide a program product.

In order to achieve the above objectives, embodiments of a first aspect of the present disclosure provide a search method for asking type query based on deep question and answer, including:

extending an asking type query, to obtain an extended query semantically related to the asking type query;

performing a search according to the extended query, to obtain pages matching the extended query;

performing a feature analysis on each of paragraphs in the pages, to obtain a score of each of the paragraphs; and

selecting a target paragraph as a search result from the paragraphs according to the score.

In order to achieve the above objectives, embodiments of a second aspect of the present disclosure provide a search device for asking type query based on deep question and answer, including:

an extending module, configured to extend an asking type query, to obtain an extended query semantically related to the asking type query;

a search module, configured to perform a search according to the extended query, to obtain pages matching the extended query;

an analyzing module, configured to perform a feature analysis on each of paragraphs in the pages, to obtain a score of each of the paragraphs; and

a selecting module, configured to select a target paragraph as a search result from the paragraphs according to the score.

In order to achieve the above objectives, embodiments of a third aspect of the present disclosure provide another search device for asking type query based on deep question and answer, including: one or more processors and a storage configured to store executable instructions by the one or more processors, wherein the one or more processors are configured to:

extend an asking type query, to obtain an extended query semantically related to the asking type query;

perform a search according to the extended query, to obtain pages matching the extended query;

perform a feature analysis on each of paragraphs in the pages, to obtain a score of each of the paragraphs; and

select a target paragraph as a search result from the paragraphs according to the score.

In order to achieve the above objectives, embodiments of a forth aspect of the present disclosure provide a non-transitory computer-readable storage medium, when instructions in the storage medium are executed by a processor of a server, the server is caused to execute a search method for asking type query based on deep question and answer, including:

extending an asking type query, to obtain an extended query semantically related to the asking type query;

performing a search according to the extended query, to obtain pages matching the extended query;

performing a feature analysis on each of paragraphs in the pages, to obtain a score of each of the paragraphs; and

selecting a target paragraph as a search result from the paragraphs according to the score.

In order to achieve the above objectives, embodiments of a fifth aspect of the present disclosure provide a program product, when instructions in the program product are executed by a processor, the processor is configured to execute a search method for asking type query based on deep question and answer, including:

extending an asking type query, to obtain an extended query semantically related to the asking type query;

performing a search according to the extended query, to obtain pages matching the extended query;

performing a feature analysis on each of paragraphs in the pages, to obtain a score of each of the paragraphs; and

selecting a target paragraph as a search result from the paragraphs according to the score.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart of a search method for asking type query based on deep question and answer according to an embodiment of the present disclosure;

FIG. 2 is a flow chart of a search method for asking type query based on deep question and answer according to another embodiment of the present disclosure;

FIG. 3 is a flow chart of a search method for asking type query based on deep question and answer according to yet another embodiment of the present disclosure;

FIG. 4 is a schematic diagram showing a comparison of search results;

FIG. 5 is a block diagram of a search device for asking type query based on deep question and answer according to an embodiment of the present disclosure;

FIG. 6 is a block diagram of extending module 51 according to an embodiment of the present disclosure;

FIG. 7 is a block diagram of extending module 51 according to another embodiment of the present disclosure; and

FIG. 8 is a block diagram of a search device for asking type query based on deep question and answer according to another embodiment of the present disclosure.

### DETAILED DESCRIPTION

Reference will be made in detail to embodiments of the present disclosure. Examples of the embodiments of the present disclosure will be shown in drawings, in which the same or similar elements and the elements having same or similar functions are denoted by like reference numerals throughout the descriptions. The embodiments described herein according to drawings are explanatory and illustrative, not construed to limit the present disclosure.

The search method and the search device for asking type query based on deep question and answer according to embodiments of the present disclosure will be described with reference to drawings.

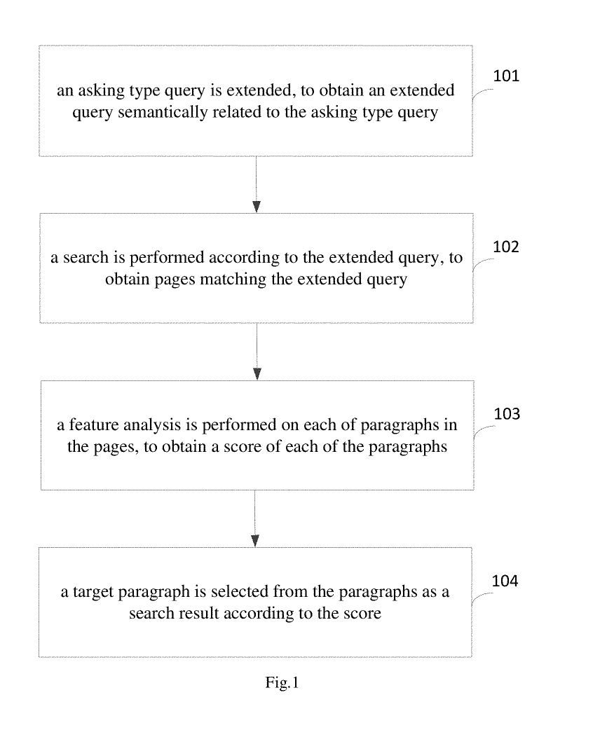

FIG. 1 is a flow chart of a search method for asking type query based on deep question and answer according to an embodiment of the present disclosure. The search method provided in this embodiment of the present disclosure can be applied in a search engine having a search function.

As shown in FIG. 1, the search method for asking type query based on deep question and answer includes the followings.

In block 101, an asking type query is extended, to obtain an extended query semantically related to the asking type query.

The asking type query is a query for raising a question to search for an answer to the question.

In an embodiment, the asking type query can be extended based on semanteme, thus obtaining the extended query semantically related to the asking type query. Two possible implementations are provided in this embodiment.

As one possible implementation, history records are queried, and at least two pages selected to view when a same user performs a search according to a same query are determined. A title of a target page in the at least two pages contains the asking type query. And then, a title of a page other than the target page the target page in the at least two pages is determined as the extended query.

As the other possible implementation, a subject word of the asking type query is extracted, a history query containing the subject word is searched for from a history record, and the history query is determined as the extended query.

In block 102, a search is performed according to the extended query, to obtain pages matching the extended query.

In an embodiment, a match can be performed between the extended query and each of pages in the internet. Literal match can be used in the matching to obtain pages matching the extended query.

In block 103, a feature analysis is performed on each of paragraphs in the pages, to obtain a score of each of the paragraphs.

In an embodiment, paragraphing processing is performed on each of the pages obtained in the block 102 to obtain paragraphs semantically independent from each other. And then the feature analysis is performed according to features of each of the paragraphs, to obtain the score of each of the paragraphs.

The features may include at least one of a digital feature, an entity feature, an alignment feature, an aggregation feature and a list feature or any combination thereof. Thus, when the feature analysis is performed according to extracted features of each of the paragraphs to obtain the score of each of the paragraphs, the score of each of the paragraphs can be obtained according to a feature score of each of the features of a corresponding paragraph by scoring with a machine learning model pre-trained with feature weights.

The score of a paragraph can indicate a probability that the paragraph will be able to answer a question raised by the asking type query. In general, the higher the score of a paragraph is, the greater the probability that the paragraph becomes an answer is.

In block 104, a target paragraph is selected from the paragraphs as a search result according to the score.

In an embodiment, a target paragraph having a score larger than a preset score is selected from the paragraphs.

Further, as a possible implementation, after the target paragraph is obtained, a page base containing the target paragraph of the asking type query is established. Thus paragraphs to be displayed in a search result page can be selected from the page base when a search is performed according to the asking type query.

As another possible implementation, the asking type query in block 101 is a query to be searched for and input online by a user, thus after the target paragraph is obtained, the target paragraph can be displayed in a search result page returned to the user.

In this embodiment, by extending the asking type query, to obtain an extended query semantically related to the asking type query, and performing the search according to the extended query to obtain the pages matching the extended query, and then performing the feature analysis on each of paragraphs in the pages to obtain the score of each of the paragraphs, selecting the target paragraph as the search result from the paragraphs according to the score, the asking type query is extended, thus enlarging a scope of searchable pages, solving the problem that search results are not comprehensive enough, and search efficiency is poor.

In order to clearly illustrate the above embodiment, an embodiment of the present disclosure provides another search method for asking type query.

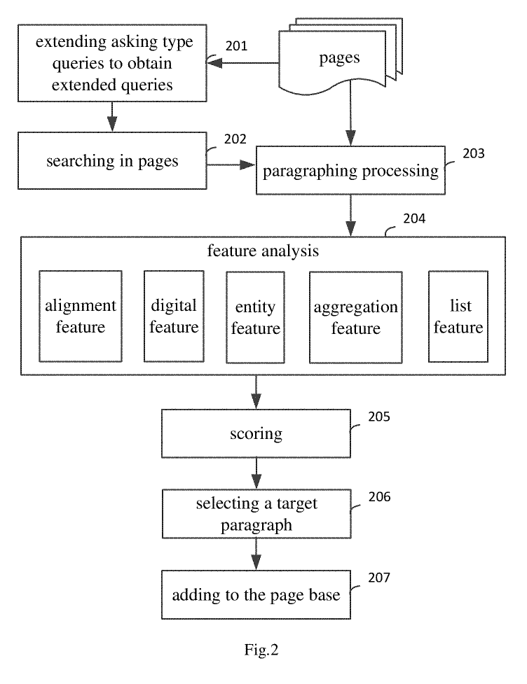

FIG. 2 is a flow chart of a search method for asking type query based on deep question and answer according to another embodiment of the present disclosure.

As shown in FIG. 2, the search method for asking type query includes the followings.

In block 201, when establishing the page base, asking type queries used in history search processes are extended, to obtain extended queries semantically related to the asking type queries. As one possible implementation, history records can be queried, and at least two pages selected to view when a same user performs a search according to a same query are determined. A title of a target page in the at least two pages contains the asking type query. And then, a title of a page other than the target page in the at least two pages is determined as the extended query.

In an embodiment, if a same user clicks two different pages when performing search according to a same query, the two different pages are considered to be similar. For example, when performing search according to a same query, a user clicks a page http://muzhi.baidu.com/question/61640793075645****.html, a title (i.e., Can angelica be used for a long time) of this page can be used as an extended query of a title (“effect, function and contraindications of angelica”) of a similar page.

As the other possible implementation, a subject word of each of the asking type queries is extracted, history queries containing the subject word are searched for from history records, and the history queries are determined as extended queries of a corresponding asking type query.

For example, firstly, a subject word “angelica” of a current query “Can angelica be used for a long time? Is there any side effect?” is extracted and then history queries containing the subject word are inquired from the history record. The acquired history queries are regarded as extended queries of a corresponding asking type query. The extended queries may be “effect and function of angelica”, “effect of eggs boiled with angelica and brown sugar”, or the like.

In block 202, searches are performed according to each of the extended queries correspondingly, to obtain pages matching each of the extended queries.

In an embodiment, the searches are performed by the search engine, to obtain search results.

Several pages ranked at the top are obtained from the search results.

It should be noted that, a purpose of the present disclosure is to acquire an answer to a question, thus, the pages mentioned here are mainly pages for displaying text information.

In block 203, paragraphing processing is performed on each of the pages, to obtain paragraphs semantically independent from each other.

The paragraphs semantically independent from each other are obtained by performing webpage structure analysis and paragraph independence analysis, used as basic units for subsequent feature analysis and ranking.

For example, a page contains following text: “State analysis: Hello, angelica can enrich blood and moisten the intestines, and its nature is warm. Guidance: If you get a blood deficiency, but no fever, you can use angelica, if you are easy to get excessive internal heat or loose stools, less or do not use, which varies from person to person. There is no problem for a suitable people to use for a long time, but for an unsuitable people, eating a little may bring illness.”

After the paragraphing processing is performed, two paragraphs are obtained.

Paragraph 1: “State analysis: Hello, angelica can enrich blood and moisten the intestines, and its nature is warm.”

Paragraph 2: “Guidance: If you get a blood deficiency, but no fever, you can use angelica, if you are easy to get excessive internal heat or loose stools, less or do not use, which varies from person to person. There is no problem for a suitable people to use for a long time, but for an unsuitable people, eating a little may bring illness.”

In block 204, a feature analysis is performed on each of paragraphs, to obtain scores of a plurality of features of each of the paragraphs.

The features include at least one of a digital feature, an entity feature, an alignment feature, an aggregation feature and a list feature or any combination thereof.

In an embodiment, the feature analysis in block 204 can be performed from multiple feature dimensions. As a possible implementation, feature analysis can be performed from feature dimensions of a field feature, the alignment feature, and the aggregation feature respectively. The field feature includes digit, entity, how, why, list, and the like. Thus by using unique text or structure feature of the field answer, it may be measured whether a paragraph is an answer to the question raised by the query according to the feature score. For example, an answer to a digital type question is usually a combination of a digit and a unit. When a feature score indicating the digital feature of a page is high, it is likely that the page contains an answer to a digital type question.

In addition, for the alignment feature, it is calculated whether sentences in a paragraph answer to the question raised by the query by performing a statistic on the question and answer so as to acquire a situation of alignment between each word in a question and sentences in an answer or acquire a probability that each word in the question and the sentences in the answer appear together.

For the aggregation feature, importance degree calculation and ranking are performed on sentences in a paragraph, and finally confidence coefficient calculation is performed on paragraphs potentially containing an answer according to the result of the ranking and the importance degree calculation.

In block 205, for each paragraph, the score of the paragraph is obtained according to feature scores of a plurality of features of the paragraph by scoring with a machine learning model pre-trained with feature weights.

As a possible implementation, a learning to rank (LTR for short) model in a supervised machine learning model can be used to learn feature weights of features of the paragraph in advance.

In block 206, a target paragraph having a score larger than a preset score is selected from the paragraphs.

In block 207, the target is added to the page base containing the target paragraph of the asking type query.

In an embodiment, when a search is performed according to the asking type query, paragraphs to be displayed in a search result page can be selected from the page base.

It should be noted that, the process of establishing the page base can be completed by acts 201-207. The page base contains pages matching each of extended queries of the asking type queries, thus the page base can be used as supplement of search results, and a situation that a user can not acquire an answer of a required question caused by incomprehensive search results is avoided.

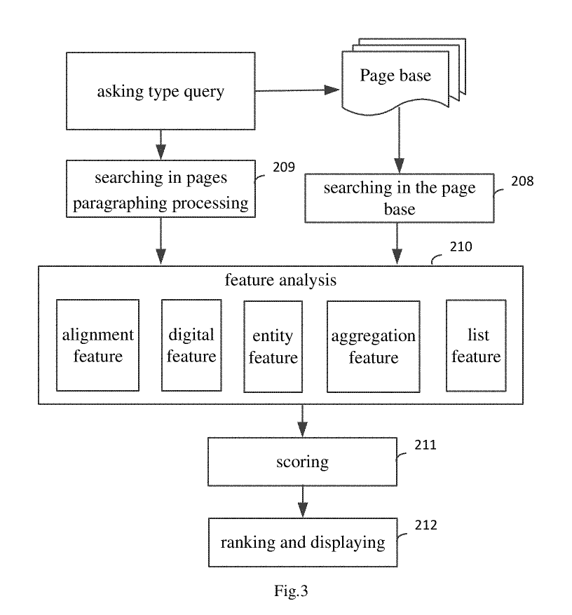

In order to clearly illustrate the above embodiment, an embodiment of the present disclosure provides another search method for asking type query. FIG. 3 is a flow chart of a search method for asking type query based on deep question and answer according to yet another embodiment of the present disclosure.

After block 207 is executed and the page base is established, as shown in FIG. 3, the search method for asking type query includes the followings.

In block 208, when a search is performed, a page base corresponding to an asking type query input online by a user is searched, and paragraphs in the page base are obtained.

In block 209, matching pages are obtained by searching in pages in whole network according to the asking type query input online by the user, and paragraphing processing is performed on the matching pages to obtain matching paragraphs.

In block 210, a feature analysis is performed on the paragraphs in the page base and the paragraphs obtained by performing the paragraphing processing on the matching pages, to obtain a plurality of feature scores of each of the paragraphs.

In block 211, paragraph feature weighting is performed on the plurality of feature scores of each of the paragraphs, to obtain a score of each of the paragraphs.

In an embodiment, the score of each of the paragraphs is obtained according to the plurality of feature scores of each of the paragraphs by scoring with a machine learning model pre-trained with feature weights.

As a possible implementation, a learning to rank (LTR for short) model in a supervised machine learning model can be used to learn feature weights of features of the paragraph in advance.

In block 212, the paragraphs are ranked according to the score of each of the paragraphs, and a preset number of paragraphs ranked at the top are displayed in a search result page.

Specifically, in order to illustrate displaying effect, this embodiment provides a schematic diagram showing a comparison of search results in FIG. 4, in which, left part shows search results in the related art, and right part shows search results obtained by using the search method according to embodiments of the present disclosure.

It can be seen from the right part of FIG. 4 that, pages that contain an answer to the question but have a poor hit of words in the search results can be recalled. Therefore, with the method according to this embodiment, the page base is established for pages containing an answer, thus relevance of searching can be improved, and pages actually containing an answer are ranked at the top of the search results, improving search effectiveness.

It can be seen that, in this embodiment, by extending the asking type query, to obtain an extended query semantically related to the asking type query, and performing the search according to the extended query to obtain the pages matching the extended query, and then performing the feature analysis on each of paragraphs in the pages to obtain the score of each of the paragraphs, selecting the target paragraph as the search result from the paragraphs according to the score, the asking type query is extended, thus enlarging a scope of searchable pages, solving the problem that search results are not comprehensive enough, and search efficiency is poor. In addition, by establishing the page base corresponding to the asking type query offline in advance, search speed when the user searches online is sped up, search efficiency is improved while load of the search engine is reduced.

To realize the above embodiments, the present disclosure further provides a search device for asking type query based on deep question and answer.

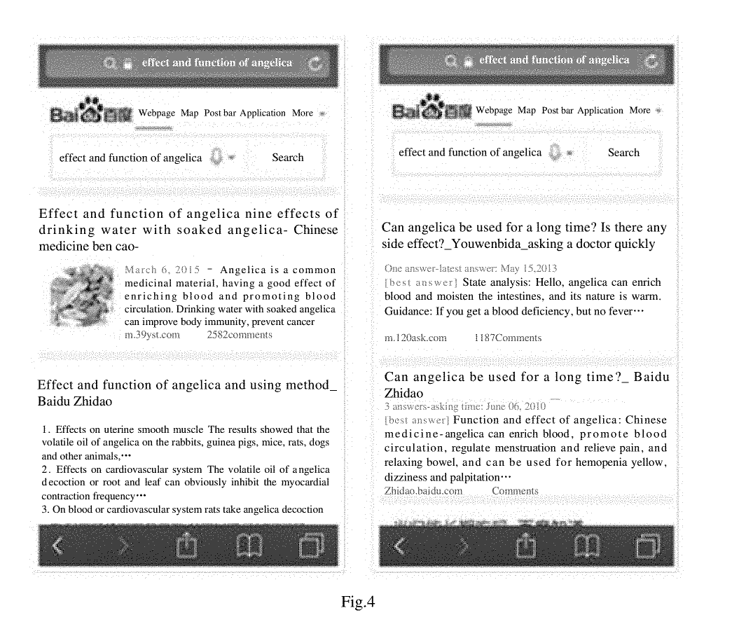

FIG. 5 is a block diagram of a search device for asking type query based on deep question and answer according to an embodiment of the present disclosure. As shown in FIG. 5, the search device for asking type query based on deep question and answer includes an extending module 51, a search module 52, an analyzing module 53, and a selecting module 54.

The extending module 51 is configured to extend an asking type query, to obtain an extended query semantically related to the asking type query.

The search module 52 is configured to perform a search according to the extended query, to obtain pages matching the extended query.

The analyzing module 53 is configured to perform a feature analysis on each of paragraphs in the pages, to obtain a score of each of the paragraphs.

The selecting module 54 is configured to select a target paragraph as a search result from the paragraphs according to the score.

In an embodiment, the selecting module 54 is configured to select a target paragraph having a score larger than a preset score from the paragraphs.

In this embodiment, by extending the asking type query, to obtain an extended query semantically related to the asking type query, and performing the search according to the extended query to obtain the pages matching the extended query, and then performing the feature analysis on each of paragraphs in the pages to obtain the score of each of the paragraphs, selecting the target paragraph as the search result from the paragraphs according to the score, the asking type query is extended, thus enlarging a scope of searchable pages, solving the problem that search results are not comprehensive enough, and search efficiency is poor.

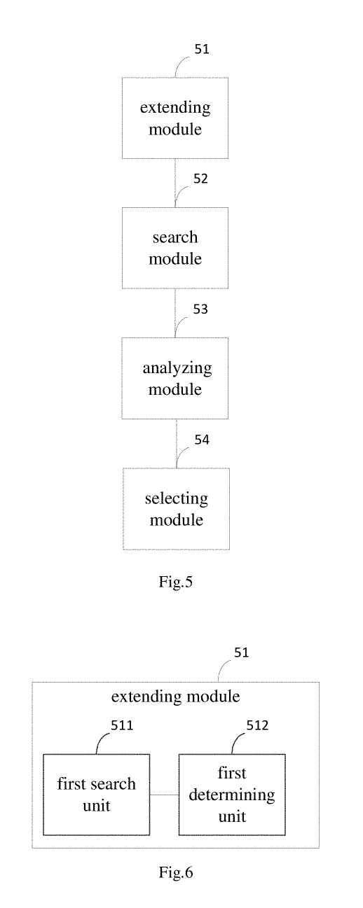

In order to realize the above embodiments, embodiments provide a possible implementation of the extending module 51. FIG. 6 is a block diagram of extending module 51 according to an embodiment of the present disclosure. As shown in FIG. 6, the extending module 51 includes a first search unit 511 and a first determining unit 512.

The first search unit 511 is configured to query history records, and to determine at least two pages selected to view when a same user performs a search according to a same query, in which a title of a target page in the at least two pages contains the asking type query.

The first determining unit 512 is configured to determine a title of a page other than the target page in the at least two pages as the extended query.

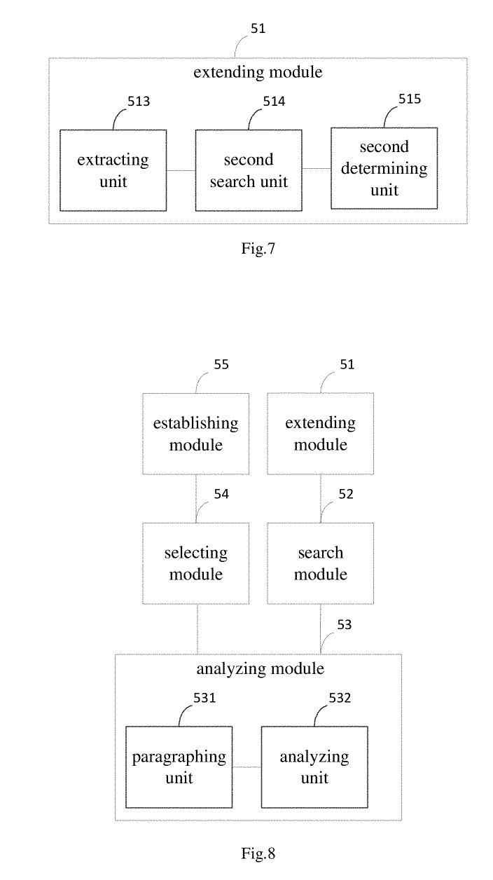

Further, embodiments also provide another possible implementation of the extending module 51. FIG. 7 is a block diagram of extending module 51 according to another embodiment of the present disclosure. As shown in FIG. 7, the extending module 51 includes an extracting unit 513, a second search unit 514, and a second determining unit 515.

The extracting unit 513 is configured to extract a subject word of the asking type query.

The second search unit 514 is configured to search for a history query containing the subject word from a history record.

The second determining unit 515 is configured to determine the history query as the extended query.

Further, in a possible implementation of embodiments of the present disclosure, FIG. 8 is a block diagram of a search device for asking type query based on deep question and answer according to another embodiment of the present disclosure. Based on FIG. 5, the analyzing module 53 in the search device shown in FIG. 8 includes a paragraphing unit 531 and an analyzing unit 532.

The paragraphing unit 531 is configured to perform paragraphing processing on the pages, to obtain the paragraphs semantically independent from each other.

The analyzing unit 532 is configured to perform the feature analysis according to features of each of the paragraphs, to obtain the score of each of the paragraphs.

The analyzing unit 532 is configured to extract the features of each of the paragraphs, to obtain a feature score of each of the features, and to obtain the score of each of the paragraphs according to the feature score of each of the features by scoring with a machine learning model pre-trained with feature weights. The features include at least one of a digital feature, an entity feature, an alignment feature, an aggregation feature and a list feature or any combination thereof.

Further, in a possible implementation of embodiments of the present disclosure, the search device for asking type query based on deep question and answer includes an establishing module 55.

The establishing module 55 is configured to establish a page base containing the target paragraph of the asking type query. When a search is performed according to the asking type query, paragraphs to be displayed in a search result page are selected from the page base.

In this embodiment, by extending the asking type query, to obtain an extended query semantically related to the asking type query, and performing the search according to the extended query to obtain the pages matching the extended query, and then performing the feature analysis on each of paragraphs in the pages to obtain the score of each of the paragraphs, selecting the target paragraph as the search result from the paragraphs according to the score, the asking type query is extended, thus enlarging a scope of searchable pages, solving the problem that search results are not comprehensive enough, and search efficiency is poor.

In order to realize the above embodiments, the present disclosure also provides another search device for asking type query based on deep question and answer, including one or more processors and a storage configured to store executable instructions by the one or more processors.

The one or more processors are configured to: extend an asking type query, to obtain an extended query semantically related to the asking type query; perform a search according to the extended query, to obtain pages matching the extended query; perform a feature analysis on each of paragraphs in the pages, to obtain a score of each of the paragraphs; and select a target paragraph as a search result from the paragraphs according to the score.

In order to realize the above embodiments, the present disclosure also provides a non-transitory computer-readable storage medium. When instructions in the storage medium are executed by a processor, the processor is caused to execute a search method for asking type query based on deep question and answer, including: extending an asking type query, to obtain an extended query semantically related to the asking type query; performing a search according to the extended query, to obtain pages matching the extended query; performing a feature analysis on each of paragraphs in the pages, to obtain a score of each of the paragraphs; and selecting a target paragraph as a search result from the paragraphs according to the score.

In order to realize the above embodiments, the present disclosure also provides a program product. When instructions in the program product are executed by a processor, the processor is configured to execute a search method for asking type query based on deep question and answer, including: extending an asking type query, to obtain an extended query semantically related to the asking type query; performing a search according to the extended query, to obtain pages matching the extended query; performing a feature analysis on each of paragraphs in the pages, to obtain a score of each of the paragraphs; and selecting a target paragraph as a search result from the paragraphs according to the score.

It can be seen that, by extending the asking type query, to obtain an extended query semantically related to the asking type query, and performing the search according to the extended query to obtain the pages matching the extended query, and then performing the feature analysis on each of paragraphs in the pages to obtain the score of each of the paragraphs, selecting the target paragraph as the search result from the paragraphs according to the score, the asking type query is extended, thus enlarging a scope of searchable pages, solving the problem that search results are not comprehensive enough, and search efficiency is poor.

Reference throughout this specification to “one embodiment”, “some embodiments,” “an embodiment”, “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples. In addition, in a case without contradictions, different embodiments or examples or features of different embodiments or examples may be combined by those skilled in the art.

Those skilled in the art shall understand that terms such as “first” and “second” are used herein for purposes of description and are not intended to indicate or imply relative importance or significance. Thus, the feature defined with “first” and “second” may comprise one or more this feature. In the description of the present disclosure, “a plurality of” means two or more than two, like two or three, unless specified otherwise.

It will be understood that, the flow chart or any process or method described herein in other manners may represent a module, segment, or portion of code that comprises one or more executable instructions to implement the specified logic function(s) or that comprises one or more executable instructions of the steps of the progress. And the scope of a preferred embodiment of the present disclosure includes other implementations in which the order of execution may differ from that which is depicted in the flow chart, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that the various parts of the present disclosure may be realized by hardware, software, firmware or combinations thereof. In the above embodiments, a plurality of steps or methods may be stored in a memory and achieved by software or firmware executed by a suitable instruction executing system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable memory medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable memory medium.

The above-mentioned memory medium may be a read-only memory, a magnetic disc, an optical disc, etc. Although explanatory embodiments have been shown and described, it would be appreciated that the above embodiments are explanatory and cannot be construed to limit the present disclosure, and changes, alternatives, and modifications can be made in the embodiments without departing from scope of the present disclosure by those skilled in the art.

What is claimed is:

1. A search method for asking type query based on deep question and answer, comprising:
extending an asking type query, to obtain an extended query semantically related to the asking type query;
performing a search according to the extended query, to obtain pages matching the extended query;
performing a feature analysis on each of paragraphs in the pages, to obtain a score of each of the paragraphs; and
selecting a target paragraph as a search result from the paragraphs according to the score.

2. The method according to claim 1, wherein extending an asking type query, to obtain an extended query semantically related to the asking type query comprises:
querying history records, and determining at least two pages selected to view when a same user performs a search according to a same query, wherein a title of a target page in the at least two pages contains the asking type query; and
determining a title of a page other than the target page in the at least two pages as the extended query.

3. The method according to claim 1, wherein extending an asking type query, to obtain an extended query semantically related to the asking type query comprises:
extracting a subject word of the asking type query;
searching for a history query containing the subject word from a history record; and
determining the history query as the extended query.

4. The method according to claim 1, wherein performing a feature analysis on each of paragraphs in the webpages, to obtain a score of each of the paragraphs comprises:
performing paragraphing processing on the pages, to obtain the paragraphs semantically independent from each other; and
performing the feature analysis according to features of each of the paragraphs, to obtain the score of each of the paragraphs.

5. The method according to claim 2, wherein performing a feature analysis on each of paragraphs in the webpages, to obtain a score of each of the paragraphs comprises:
performing paragraphing processing on the pages, to obtain the paragraphs semantically independent from each other; and
performing the feature analysis according to features of each of the paragraphs, to obtain the score of each of the paragraphs.

6. The method according to claim 3, wherein performing a feature analysis on each of paragraphs in the webpages, to obtain a score of each of the paragraphs comprises:
performing paragraphing processing on the pages, to obtain the paragraphs semantically independent from each other; and
performing the feature analysis according to features of each of the paragraphs, to obtain the score of each of the paragraphs.

7. The method according to claim 4, wherein performing the feature analysis according to features of each of the paragraphs, to obtain the score of each of the paragraphs comprises:
extracting the features of each of the paragraphs, and obtaining a feature score of each of the features, wherein the features comprise at least one of a digital feature, an entity feature, an alignment feature, an aggregation feature and a list feature or any combination thereof; and
obtaining the score of each of the paragraphs according to the feature score of each of the features by scoring with a machine learning model pre-trained with feature weights.

8. The method according to claim 1, wherein selecting a target paragraph as a search result from the paragraphs according to the score comprises:
selecting a target paragraph having a score larger than a preset score from the paragraphs.

9. The method according to claim 1, after selecting a target paragraph as a search result from the paragraphs according to the score, further comprising:
establishing a page base containing the target paragraph of the asking type query;
when searching according to the asking type query, selecting paragraphs to be displayed in a search result page from the page base.

10. A search device for asking type query based on deep question and answer, comprising:
one or more processors;
a memory storing instructions executable by the one or more processors;
wherein the one or more processors are configured to:
extend an asking type query, to obtain an extended query semantically related to the asking type query;
perform a search according to the extended query, to obtain pages matching the extended query;
perform a feature analysis on each of paragraphs in the pages, to obtain a score of each of the paragraphs; and
select a target paragraph as a search result from the paragraphs according to the score.

11. The device according to claim 10, wherein the one or more processors are configured to extend an asking type query, to obtain an extended query semantically related to the asking type query by acts of:
querying history records, and determining at least two pages selected to view when a same user performs a search according to a same query, wherein a title of a target page in the at least two pages contains the asking type query; and
determining a title of a page other than the target page in the at least two pages as the extended query.

12. The device according to claim 10, wherein the one or more processors are configured to extend an asking type query, to obtain an extended query semantically related to the asking type query by acts of:
extracting a subject word of the asking type query;
searching for a history query containing the subject word from a history record; and
determining the history query as the extended query.

13. The device according to claim 10, wherein the one or more processors are configured to perform a feature analysis on each of paragraphs in the webpages, to obtain a score of each of the paragraphs by acts of:
performing paragraphing processing on the pages, to obtain the paragraphs semantically independent from each other; and
performing the feature analysis according to features of each of the paragraphs, to obtain the score of each of the paragraphs.

14. The device according to claim 11, wherein the one or more processors are configured to perform a feature analysis on each of paragraphs in the webpages, to obtain a score of each of the paragraphs by acts of:
performing paragraphing processing on the pages, to obtain the paragraphs semantically independent from each other; and
performing the feature analysis according to features of each of the paragraphs, to obtain the score of each of the paragraphs.

15. The device according to claim 12, wherein the one or more processors are configured to perform a feature analysis on each of paragraphs in the webpages, to obtain a score of each of the paragraphs by acts of:
performing paragraphing processing on the pages, to obtain the paragraphs semantically independent from each other; and
performing the feature analysis according to features of each of the paragraphs, to obtain the score of each of the paragraphs.

16. The device according to claim 13, wherein the analyzing unit is configured to:
extract the features of each of the paragraphs, and obtain a feature score of each of the features, wherein the features comprise at least one of a digital feature, an entity feature, an alignment feature, an aggregation feature and a list feature or any combination thereof; and
obtain the score of each of the paragraphs according to the feature score of each of the features by scoring with a machine learning model pre-trained with feature weights.

17. The device according to claim 10, wherein the selecting module is configured to:
select a target paragraph having a score larger than a preset score from the paragraphs.

18. The device according to claim 10, further comprising:
an establishing module, configured to establish a page base containing the target paragraph of the asking type query; wherein
when searching according to the asking type query, paragraphs to be displayed in a search result page are selected from the page base.

19. A non-transitory computer-readable storage medium having stored therein instructions that, when executed by a processor of a device, cause the processor to perform a search method for asking type query based on deep question and answer, the method comprising:
extending an asking type query, to obtain an extended query semantically related to the asking type query;
performing a search according to the extended query, to obtain pages matching the extended query;
performing a feature analysis on each of paragraphs in the pages, to obtain a score of each of the paragraphs; and
selecting a target paragraph as a search result from the paragraphs according to the score.
